(19) United States
(12) Patent Application Publication
(10) Pub. No.: US 2026/0031575 A1
(43) Pub. Date: Jan. 29, 2026

(54) Terminal Module and Connector

(71) Applicants: Tyco Electronics Holdings (Bermuda) No. 7 Limited, Hamilton (BM); Tyco Electronics (Shanghai) Co., Ltd., Shanghai (CN); TE Connectivity Belgium BV, Oostkamp (BE)

(72) Inventors: Chunming (Richard) Yu, Shanghai (CN); Guangming (Suny) Zhao, Shanghai (CN); Josh Jiang, Hamilton (BM); Lieven Decrock, Oostkamp (BE); Xingjie (Steven) GE, Shanghai (CN)

(73) Assignees: Tyco Electronics Holdings (Bermuda) No. 7 Limited, Hamilton (BM); Tyco Electronics (Shanghai) Co., Ltd., Shanghai (CN); TE Connectivity Belgium BV, Oostkamp (BE)

(21) Appl. No.: 19/278,921

(22) Filed: Jul. 24, 2025

(30) Foreign Application Priority Data
Jul. 25, 2024 (CN) 202421783924.9

(51) Int. Cl. H01R 13/6581; H01R 12/55; H01R 13/02; H01R 13/405; H01R 13/506

(52) U.S. Cl. CPC H01R 13/6581; H01R 12/55; H01R 13/02; H01R 13/405; H01R 13/506

(57) ABSTRACT

A terminal module includes a row of terminals, each terminal having a fixing part and an elastic arm, and a welding pin connected to ends of the fixing part respectively. A holder of the terminal is integrally formed with the fixing parts of the row of terminals. A shielding assembly of the terminal includes a shielding member and an insulation member. The shielding member has a strip-shaped shielding body and multiple pairs of welding legs connected to the strip-shaped shielding body, the multiple pairs of welding legs of the shielding member are respectively welded to the elastic arms of multiple ground terminals in the row of terminals. The insulation member defines a strip and is attached to the bottom side of the strip shielding body, the insulation member is located between the elastic arms of the row of terminals and the strip-shaped shielding body.

### CROSS-REFERENCE TO RELATED APPLICATION

This application claims the benefit of Chinese Patent Application No. CN202421783924.9 filed on Jul. 25, 2024 in the State Intellectual Property Office of China, the whole disclosure of which is incorporated herein by reference.

### FIELD OF THE DISCLOSURE

The disclosure relates to a terminal module and a connector comprising the terminal module.

### BACKGROUND OF THE INVENTION

In the prior art, a connector typically includes a housing, a holder and a row of terminals. The holder is injected onto the row of terminals and installed into the housing. The terminal includes an elastic arm adapted to electrically contact a mating terminal and a welding pin for soldering to a circuit board. In the prior art, the impedance of the row of terminals at the elastic arm (i.e., in the mating area where they are mated with the mating terminals) is relatively high, and there is mutual crosstalk between the terminals. Improved connectors addressing these drawbacks are desired.

### SUMMARY OF THE INVENTION

According to an embodiment of the present disclosure, a terminal module includes a row of terminals, a holder and a shielding assembly. Each terminal has a fixing part, an elastic arm and a welding pin connected to ends of the fixing part respectively. The elastic arm of the terminal is adapted to electrically contact a mating terminal. The welding pin of the terminal is adapted to be soldered to a circuit board. The holder is molded onto the fixing parts of the row of terminals such that the row of terminals and the holder define integral piece. The fixing part of the terminal is adapted to be fixed to a housing of a connector through the holder. The shielding assembly includes a shielding member, and an insulation member. The shielding member has a strip-shaped shielding body and multiple pairs of welding legs connected to the strip-shaped shielding body. The multiple pairs of welding legs of the shielding member are respectively welded to the elastic arms of multiple ground terminals in the row of terminals. The insulation member is formed as a strip and is attached to the bottom side of the strip shielding body. The insulation member is located between the elastic arms of the row of terminals and the strip-shaped shielding body.

### DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a terminal module according to an exemplary embodiment of the present invention when viewed from the front side;

FIG. 2 shows an illustrative exploded view of a terminal module according to an exemplary embodiment of the present invention when viewed from the front side;

FIG. 3 shows an illustrative perspective view of the shielding assembly of a terminal module according to an exemplary embodiment of the present invention;

FIG. 4 shows an illustrative exploded view of the shielding assembly of a terminal module according to an exemplary embodiment of the present invention;

FIG. 5 shows an illustrative perspective view of a terminal module according to an exemplary embodiment of the present invention when viewed from the rear side;

FIG. 6 shows an illustrative exploded view of a terminal module according to an exemplary embodiment of the present invention when viewed from the top;

FIG. 7 shows an illustrative perspective view of a terminal module according to an exemplary embodiment of the present invention when viewed from the bottom;

FIG. 8 shows an illustrative exploded view of a terminal module according to an exemplary embodiment of the present invention when viewed from the bottom;

FIG. 9 shows an illustrative exploded view of a terminal module and an inner housing according to an exemplary embodiment of the present invention;

FIG. 10 shows an illustrative assembly view of a terminal module and an inner housing according to an exemplary embodiment of the present invention;

FIG. 11 shows an illustrative exploded view of a connector according to an exemplary embodiment of the present invention; and

FIG. 12 shows an illustrative perspective view of a connector according to an exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a terminal module comprises: a row of terminals, each terminal comprising a fixing part and an elastic arm and a welding pin connected to both ends of the fixing part respectively; a holder which is injection molded onto the fixing parts of the row of terminals, so that the row of terminals and the holder become an integral piece; and a shielding assembly. The shielding assembly includes: a shielding member comprising a strip-shaped shielding body and multiple pairs of welding legs connected to the strip-shaped shielding body; and an insulation member in the form of a strip and attached to the bottom side of the strip shielding body. The elastic arm of the terminal is used for electrical contact with a mating terminal, the welding pin of the terminal is used for soldering to a circuit board, and the fixing part of the terminal is suitable for being fixed to a housing of a connector through the holder; the multiple pairs of welding legs of the shielding member are respectively welded to the elastic arms of multiple ground terminals in the row of terminals, and the insulation member is located between the elastic arms of the row of terminals and the strip-shaped shielding body. According to another embodiment of the present disclosure, a connector comprises a housing, and the above terminal module installed in the housing.

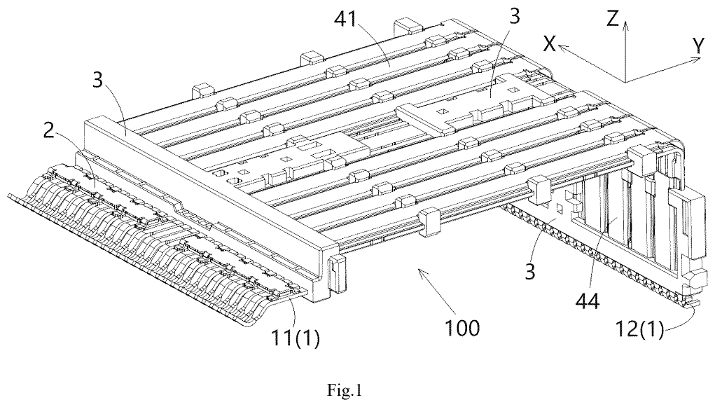

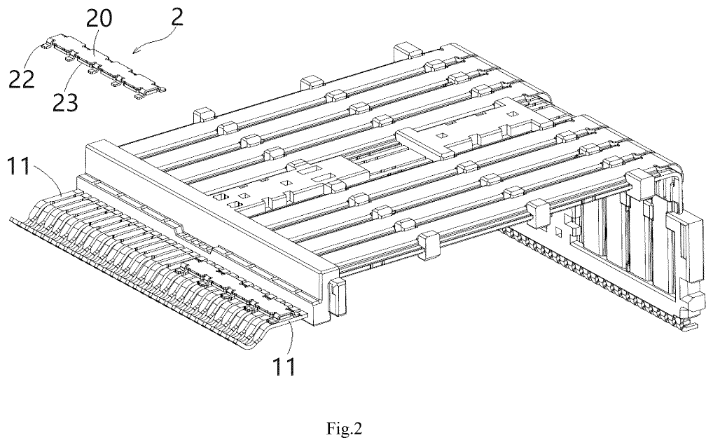

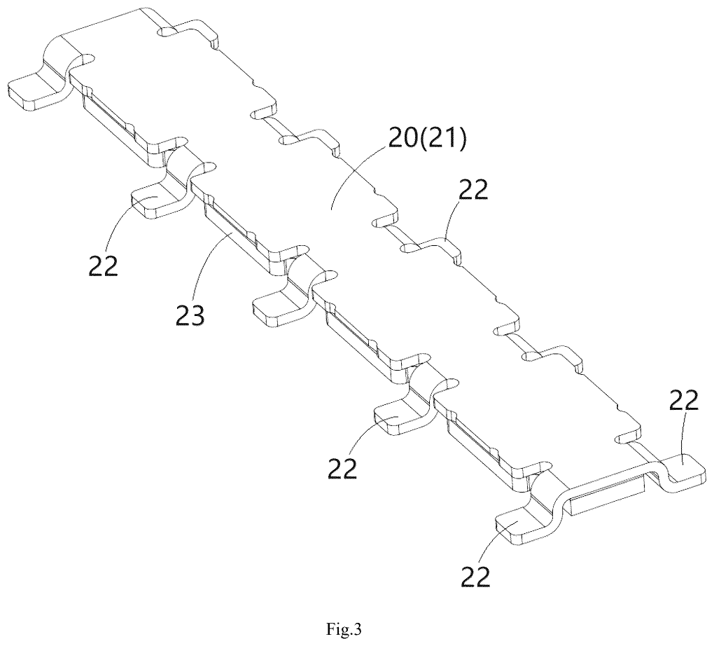

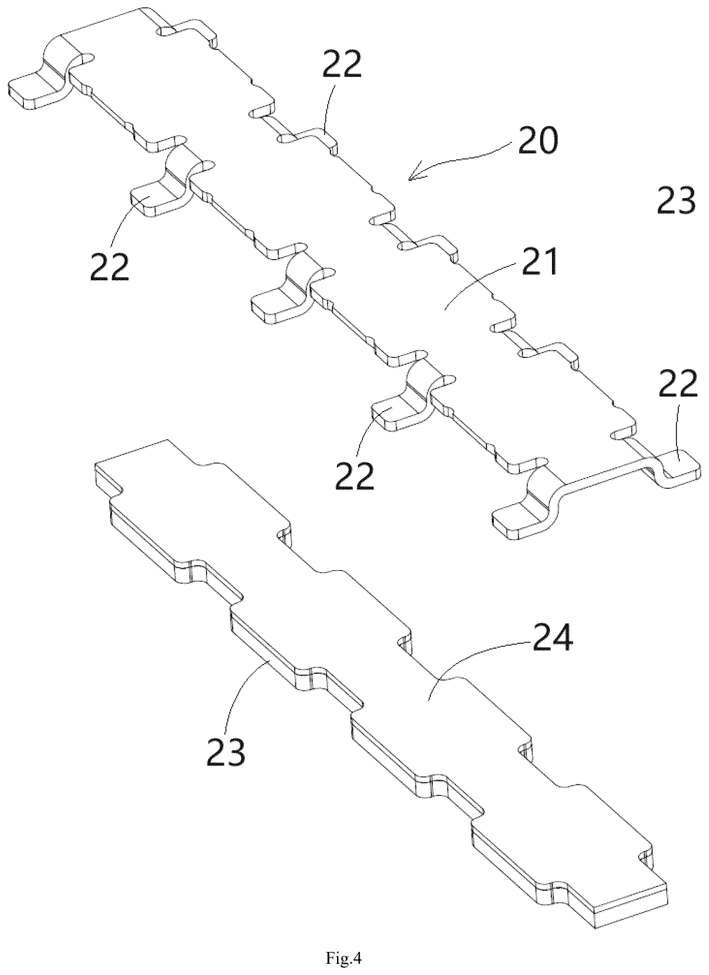

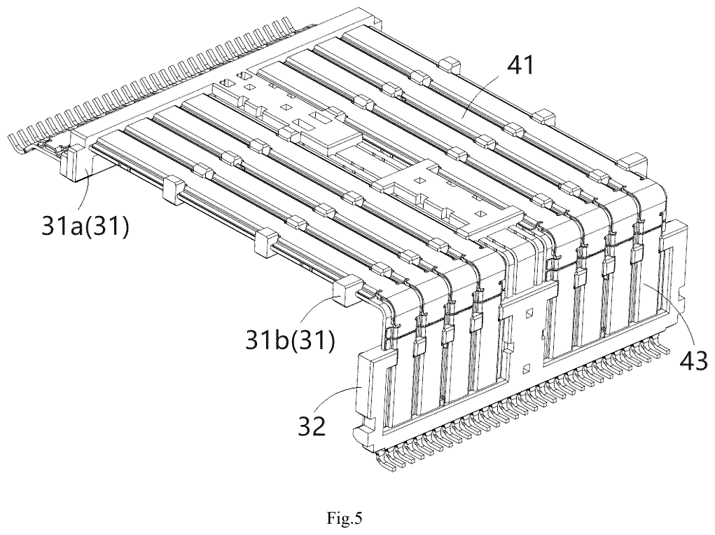

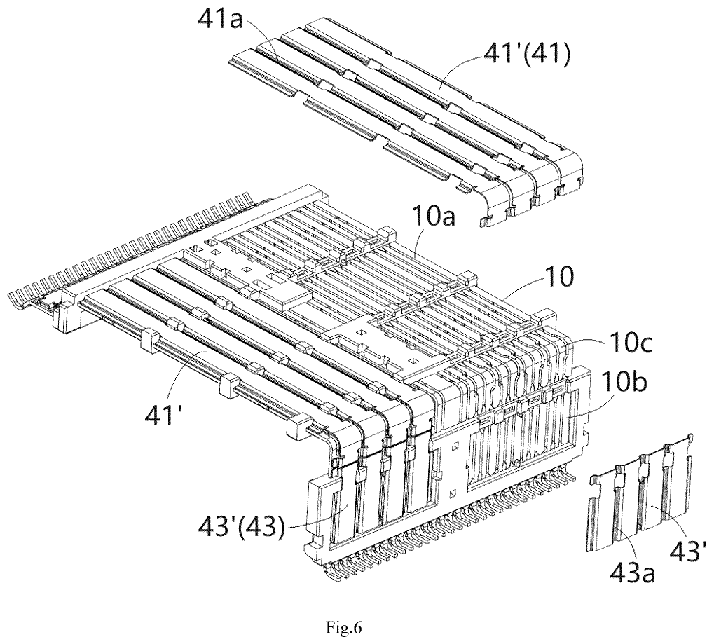

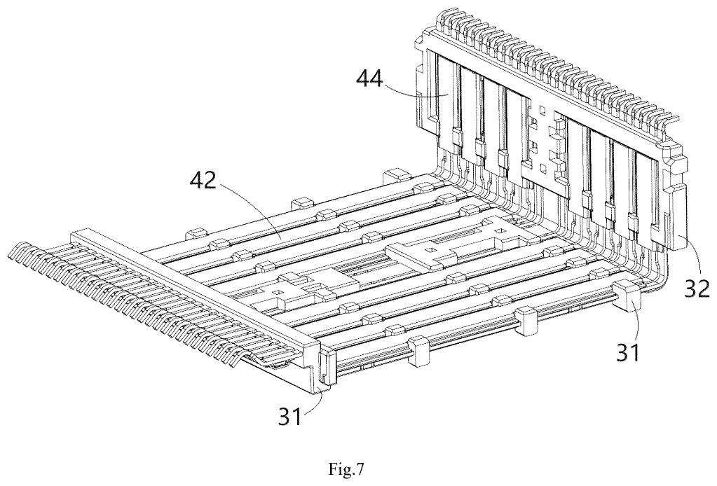

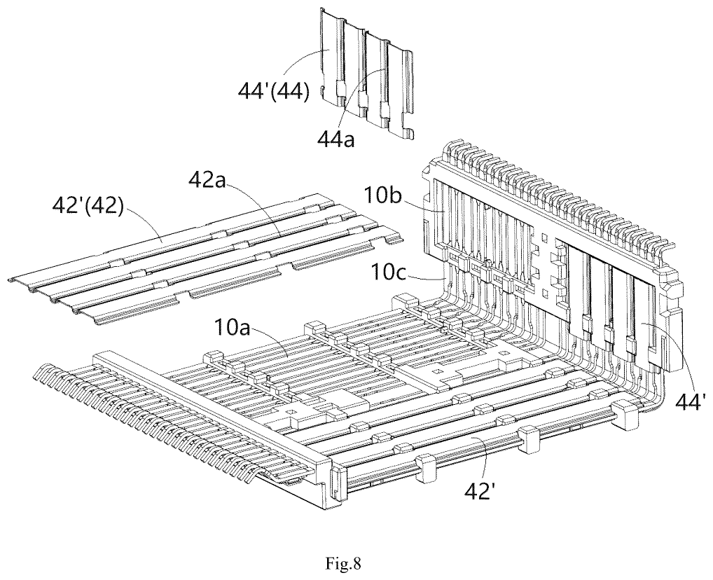

FIG. 1 shows an illustrative perspective view of a terminal module 100 according to an exemplary embodiment of the present invention when viewed from the front side. FIG. 2 shows an illustrative exploded view of terminal module 100 according to an exemplary embodiment of the present invention when viewed from the front side. FIG. 3 shows an illustrative perspective view of the shielding assembly of terminal module 100 according to an exemplary embodiment of the present invention. FIG. 4 shows an illustrative exploded view of the shielding assembly of terminal module 100 according to an exemplary embodiment of the present invention. FIG. 5 shows an illustrative perspective view of the terminal module 100 according to an exemplary embodiment of the present invention when viewed from the rear side. FIG. 6 shows an illustrative exploded view of terminal module 100 according to an exemplary embodiment of the present invention when viewed from the top. FIG. 7 shows an illustrative perspective view of terminal module 100 according to an exemplary embodiment of the present invention when viewed from the bottom. FIG. 8 shows an illustrative exploded view of terminal module 100 according to an exemplary embodiment of the present invention when viewed from the bottom.

As shown in FIGS. 1-8, in an exemplary embodiment of the present invention, a terminal module 100 is disclosed. The terminal module 100 includes a row of terminals 1, a shielding assembly 2, and a holder 3. Each terminal 1 includes a fixing part 10, as well as an elastic arm 11 and a welding pin 12 connected to both ends of the fixing part 10, respectively. The holder 3 is injection molded onto the fixing parts 10 of the row of terminals 1, so that the row of terminals 1 and the holder 3 become an integral piece.

The shielding assembly 2 includes a shielding member 20 and an insulation member 23. The shielding member 20 includes a strip-shaped shielding body 21 and multiple pairs of welding legs 22 connected to the strip-shaped shielding body 21. The insulation member 23 is in the form of a strip and is attached to the bottom side of the strip shielding body 21. The elastic arm 11 of terminal 1 is used for electrical contact with a mating terminal, the welding pin 12 of terminal 1 is used for soldering to a circuit board, and the fixing part 10 of terminal 1 is suitable for being fixed to a housing 5 of a connector through the holder 3. The multiple pairs of welding legs 22 of the shielding member 20 are respectively welded to the elastic arms 11 of multiple ground terminals in the row of terminals 1, and the insulation member 23 is located between the elastic arms 11 of the row of terminals 1 and the strip-shaped shielding body 21.

In the illustrated embodiment, the row of terminals 1 are arranged along the transverse direction X of the terminal module 100. The shielding member 20 and the insulation member 23 extend a predetermined length along the transverse direction X of the terminal module 100. Multiple pairs of welding legs 22 are spaced apart in the transverse direction X of the terminal module 100. The strip-shaped shielding body 21 has front and rear sides opposite to each other in the longitudinal direction Y of the terminal module 100. Each pair of welding legs 22 includes front and rear welding legs 22 connected to the front and rear sides of the strip-shaped shielding body 21, respectively.

The terminal module 100 includes two shielding assemblies 2 arranged side by side in its transverse direction X. The welding legs 22 of the shielding members 20 of the two shielding assemblies 2 are respectively welded to the elastic arms 11 of the ground terminals in the row of terminals 1. The elastic arms 11 of the row of terminals 1 have upper and lower sides opposite each other in the height direction Z of the terminal module 100, and the shielding assembly 2 is located on the upper side of the elastic arms 11 of the row of terminals 1. The insulation member 23 is adhered to the bottom side of the strip-shaped shielding body 21 by an adhesive 24, or the insulation member 23 is directly injected onto the bottom side of the strip-shaped shielding body 21.

The fixing part 10 of terminal 1 is L-shaped, including a horizontal extension portion 10a, a vertical extension portion 10b, and a bent transition portion 10c. The horizontal extension 10a extends along the longitudinal direction Y of the terminal module 100. The vertical extension portion 10b extends along the height direction Z of the terminal module 100. The bent transition portion 10c is connected between the rear end of the horizontal extension portion 10a and the upper end of the vertical extension portion 10b. The elastic arm 11 is connected to the front end of the horizontal extension portion 10a, and the welding pin 12 is connected to the lower end of the vertical extension portion 10b.

The holder 3 includes a first holder 31 and a second holder 32. The first holder 31 is injection molded onto the horizontal extension portion 10a of the row of terminals 1, used to hold the horizontal extension portions 10a of the row of terminals 1. The second holder 32 is injection molded onto the vertical extension portion 10b of the row of terminals 1, used to hold the vertical extension portions 10b of the row of terminals 1.

In the illustrated embodiment, the first holder 31 includes a first front holder 31a and a first rear holder 31b. The first front holder 31a is injection molded onto the front portions of the horizontal extension portions 10a of the row of terminals 1, used to retain the front portions of the horizontal extension portions 10a of the row of terminals 1. The first rear holder 31b is injection molded onto the rear portions of the horizontal extension portions 10a of the row of terminals 1, used to retain the rear portions of the horizontal extension portions 10a of the row of terminals 1. The elastic arms 11 of the row of terminals 1 extend from the front side of the first front holder 31a, and the welding pins 12 of the row of terminals I extend from the bottom of the second holder 32. The first holder 31 has top and bottom portions that are opposite in the height direction Z of the terminal module 100, and the second holder 32 has front and rear portions that are opposite in the longitudinal direction Y of the terminal module 100.

The terminal module 100 further includes a top shielding plate 41, which is installed on the top of the first holder 31 and simultaneously covers the horizontal extension portion 10a and the bent transition portion 10c of the terminal 1. Multiple top welding ribs 41a are formed on the top shielding plate 41, which are spaced apart in the transverse direction X of the terminal module 100 and respectively welded to multiple ground terminals in the row of terminals 1. The top shielding plate 41 includes two top shielding sub plates 41′ arranged side by side in the transverse direction X of the terminal module 100.

The terminal module 100 further includes a bottom shielding plate 42, which is installed on the bottom of the first holder 31 and covers the horizontal extension portion 10a of the terminal 1 or simultaneously covers the horizontal extension portion 10a and the bent transition portion 10c of the terminal 1. Multiple bottom welding ribs 42a are formed on the bottom shielding plate 42, which are spaced apart in the transverse direction X of the terminal module 100 and respectively welded to multiple ground terminals in the row of terminals 1. The bottom shielding plate 42 includes two bottom shielding sub plates 42′ arranged side by side in the transverse direction X of the terminal module 100.

The terminal module 100 further includes a rear shielding plate 43, which is installed on the rear side of the second holder 32 and covers the vertical extension portion 10b of the terminal 1. Multiple rear welding ribs 43 are formed on the rear shielding plate 43, which are spaced apart in the transverse direction X of the terminal module 100 and respectively welded to multiple ground terminals in the row of terminals 1. The rear shielding plate 43 includes two rear shielding sub plates 43′ arranged side by side in the transverse direction X of the terminal module 100.

The terminal module 100 further includes a front shielding plate 44, which is installed on the front side of the second holder 32 and covers the vertical extension portion 10b of the terminal 1. Multiple front welding ribs 44a are formed on the front shielding plate 44, which are spaced apart in the transverse direction X of the terminal module 100 and respectively welded to multiple ground terminals in the row of terminals 1. The front shielding plate 44 includes two front shielding sub plates 44′ arranged side by side in the transverse direction X of the terminal module 100.

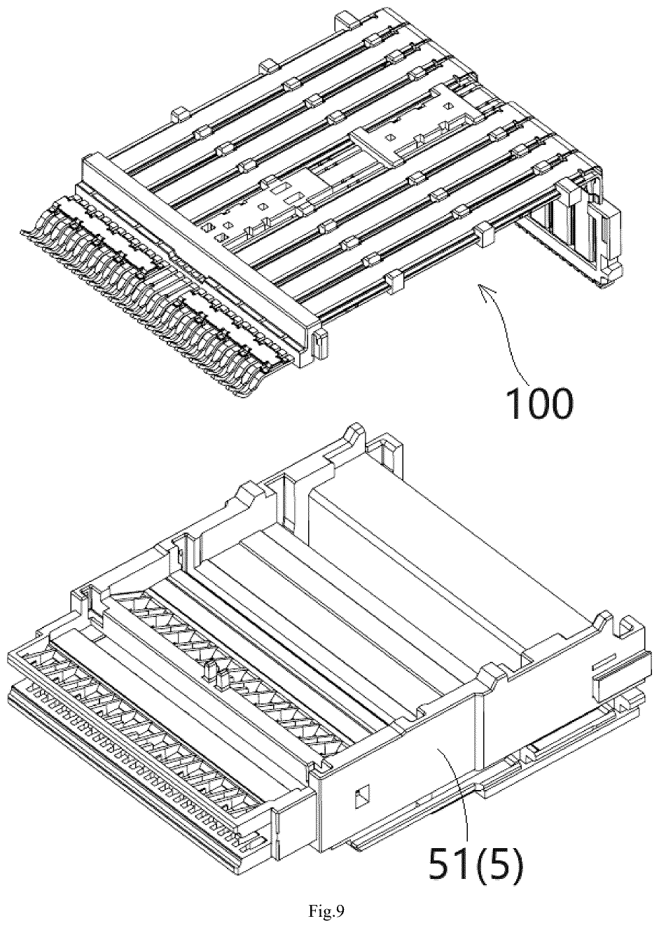

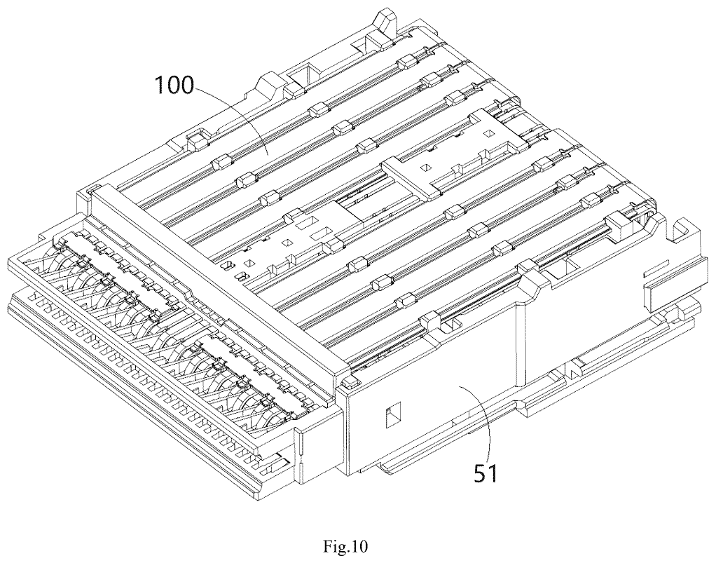

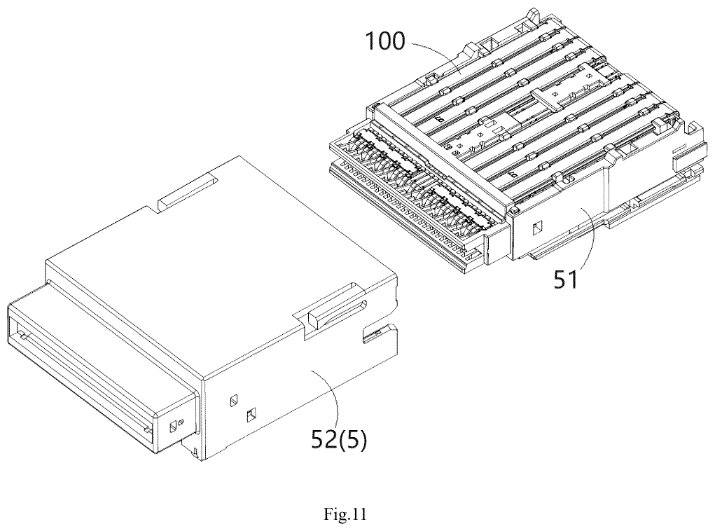

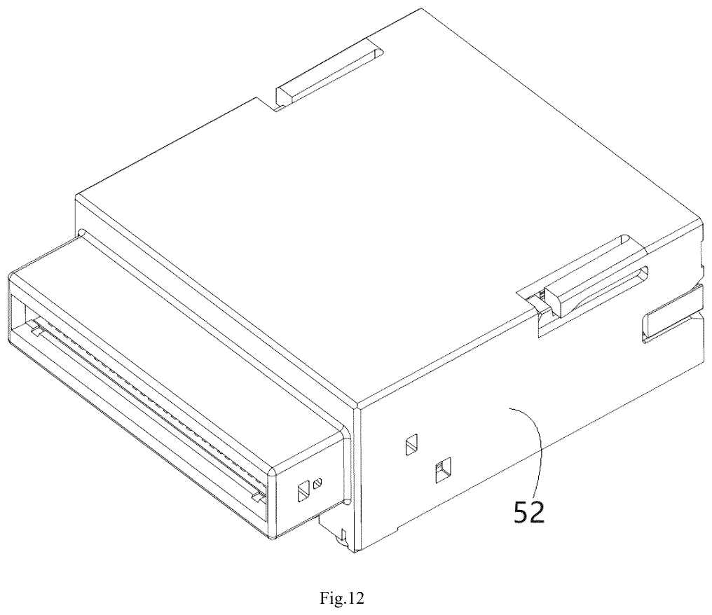

FIG. 9 shows an illustrative exploded view of terminal module 100 and inner housing 51 according to an exemplary embodiment of the present invention. FIG. 10 shows an illustrative assembly view of a terminal module 100 and an inner housing 51 according to an exemplary embodiment of the present invention. FIG. 11 shows an illustrative exploded view of a connector according to an exemplary embodiment of the present invention. FIG. 12 shows an illustrative perspective view of a connector according to an exemplary embodiment of the present invention.

As shown in FIGS. 1-12, in another exemplary embodiment of the present invention, a connector is also disclosed. The connector includes a housing 5 and a terminal module 100, with the terminal module 100 installed in the housing 5. In the illustrated embodiment, the housing 5 includes an inner housing 51 and an outer housing 52. The terminal module 100 is installed into the inner housing 51. The inner housing 51 is installed into the outer housing 52. The welding pins 12 of the row of terminals 1 of the terminal module 100 are exposed from the bottom of the outer housing 52 for soldering to a circuit board. The elastic arms 11 of the row of terminals 1 of the terminal module 100 are located in the inner housing 51 for electrical contact with mating terminals of a mating connector inserted into the inner housing 51.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A terminal module, comprising:
a row of terminals, each terminal having a fixing part and an elastic arm, and a welding pin connected to ends of the fixing part respectively, the elastic arm of the terminal is adapted to be in electrical contact with a mating terminal, and the welding pin of the terminal is adapted to be soldered to a circuit board;
a holder molded onto the fixing parts of the row of terminals such that the row of terminals and the holder define integral piece, the fixing part of the terminal is adapted to be fixed to a housing of a connector through the holder; and
a shielding assembly, including:
a shielding member having a strip-shaped shielding body and multiple pairs of welding legs connected to the strip-shaped shielding body, the multiple pairs of welding legs of the shielding member are respectively welded to the elastic arms of multiple ground terminals in the row of terminals; and
an insulation member in the form of a strip and attached to the bottom side of the strip shielding body, the insulation member is located between the elastic arms of the row of terminals and the strip-shaped shielding body.

2. The terminal module according to claim 1, wherein:
the row of terminals is arranged along the transverse direction of the terminal module, the shielding member and the insulation member extend a predetermined length along the transverse direction of the terminal module, and the multiple pairs of welding legs are spaced apart in the transverse direction of the terminal module; and
the strip-shaped shielding body has front and rear sides opposite to each other in the longitudinal direction of the terminal module, and each pair of welding legs includes front and rear welding legs connected to the front and rear sides of the strip-shaped shielding body, respectively.

3. The terminal module according to claim 1, wherein the terminal module includes two shielding assemblies arranged side by side in its transverse direction, and the welding legs of the shielding members of the two shielding assemblies are respectively welded to the elastic arms of the ground terminals in the row of terminals.

4. The terminal module according to claim 1, wherein the elastic arms of the row of terminals have upper and lower sides opposite in the height direction of the terminal module, and the shielding assembly is located on the upper side of the elastic arms of the row of terminals.

5. The terminal module according to claim 1, wherein the insulation member is directly injection molded onto the bottom side of the strip-shaped shielding body.

6. The terminal module according to claim 1, wherein the fixing part of the terminal is L-shaped, comprising:
a horizontal extension portion extending along the longitudinal direction of the terminal module;
a vertical extension portion extending along the height direction of the terminal module; and
a bent transition portion connected between the rear end of the horizontal extension portion and the upper end of the vertical extension portion, the elastic arm is connected to the front end of the horizontal extension portion, and the welding pin is connected to the lower end of the vertical extension portion.

7. The terminal module according to claim 6, wherein the holder comprises:
a first holder injection molded onto the horizontal extension portions of the row of terminals for retaining the horizontal extension portions of the row of terminals; and
a second holder injection molded onto the vertical extension portion of the row of terminals for retaining the vertical extension portions of the row of terminals.

8. The terminal module according to claim 7, wherein the first holder comprises:
a first front holder injection molded onto the front portions of the horizontal extension portions of the row of terminals, and retaining the front portions of the horizontal extension portions of the row of terminals; and
a first rear holder injection molded onto the rear portions of the horizontal extension portions of the row of terminals and retaining the rear portions of the horizontal extension portions of the row of terminals, the elastic arms of the row of terminals extend from the front side of the first front holder, and the welding pins of the row of terminals extend from the bottom of the second holder.

9. The terminal module according to claim 7, wherein the first holder has top and bottom portions that are opposite in the height direction of the terminal module, and the second holder has front and rear portions that are opposite in the longitudinal direction of the terminal module.

10. The terminal module according to claim 9, further comprising a top shielding plate installed on the top of the first holder and covering both the horizontal extension portion and the bent transition portion of the terminal.

11. The terminal module according to claim 10, wherein multiple top welding ribs are formed on the top shielding plate, and are spaced apart in the transverse direction of the terminal module and respectively welded to multiple ground terminals in the row of terminals.

12. The terminal module according to claim 10, wherein the top shielding plate comprises two top shielding sub plates arranged side by side in the transverse direction of the terminal module.

13. The terminal module according to claim 9, further comprising a bottom shielding plate installed on the bottom of the first holder and covering the horizontal extension portion of the terminal or both the horizontal extension portion and the bent transition portion of the terminal.

14. The terminal module according to claim 13, wherein multiple bottom welding ribs are formed on the bottom shielding plate, and are spaced apart in the transverse direction of the terminal module and respectively welded to multiple ground terminals in the row of terminals.

15. The terminal module according to claim 13, wherein the bottom shielding plate includes two bottom shielding sub plates arranged side by side in the transverse direction of the terminal module.

16. The terminal module according to claim 9, further comprising a rear shielding plate installed on the rear side of the second holder and covering the vertical extension portion of the terminal.

17. The terminal module according to claim 16, wherein multiple rear welding ribs are formed on the rear shielding plate, and are spaced apart in the transverse direction of the terminal module and respectively welded to multiple ground terminals in the row of terminals.

18. The terminal module according to claim 16, wherein the rear shielding plate includes two rear shielding sub plates arranged side by side in the transverse direction of the terminal module.

19. The terminal module according to claim 9, further comprising a front shielding plate installed on the front side of the second holder and covering the vertical extension portion of the terminal.

20. The terminal module according to claim 19, wherein multiple front welding ribs are formed on the front shielding plate, and are spaced apart in the transverse direction of the terminal module and respectively welded to multiple ground terminals in the row of terminals.

21. The terminal module according to claim 19, wherein the front shielding plate comprises two front shielding sub plates arranged side by side in the transverse direction of the terminal module.

22. A connector, comprising:
a housing; and
the terminal module installed in the housing, including:
a row of terminals, each terminal having a fixing part and an elastic arm, and a welding pin connected to ends of the fixing part respectively, the elastic arm of the terminal is adapted to be in electrical contact with a mating terminal, and the welding pin of the terminal is adapted to be soldered to a circuit board;
a holder molded onto the fixing parts of the row of terminals such that the row of terminals and the holder define integral piece, the fixing part of the terminal is adapted to be fixed to a housing of a connector through the holder; and
a shielding assembly, including:
a shielding member having a strip-shaped shielding body and multiple pairs of welding legs connected to the strip-shaped shielding body, the multiple pairs of welding legs of the shielding member are respectively welded to the elastic arms of multiple ground terminals in the row of terminals; and
an insulation member in the form of a strip and attached to the bottom side of the strip shielding body, the insulation member is located between the elastic arms of the row of terminals and the strip-shaped shielding body.

23. The connector according to claim 22, wherein the housing comprises:
an inner housing into which the terminal module is installed; and
an outer housing into which the inner housing is installed, the welding pins of a row of terminals of the terminal module are exposed from the bottom of the outer housing for soldering to a circuit board, the elastic arms of a row of terminals of the terminal module are located in the inner housing for electrical contact with mating terminals of a mating connector inserted into the inner housing.
